(19) United States
(12) Patent Application Publication
(10) Pub. No.: US 2009/0234848 A1
(43) Pub. Date: Sep. 17, 2009

(54) SYSTEM AND METHOD FOR RANKING SEARCH RESULTS

(76) Inventors: Andy Leff, Philadelphia, PA (US); Ron Leff, Gladwyne, PA (US); Corey McGlasson, Sicklerville, NJ (US)

Correspondence Address: MONTGOMERY, MCCRACKEN, WALKER & RHOADS, LLP, 123 SOUTH BROAD STREET, AVENUE OF THE ARTS, PHILADELPHIA, PA, 19109, US

(21) Appl. No.: 12/400,613

(22) Filed: Mar. 9, 2009

Related U.S. Application Data
(60) Provisional application No. 61/068,616, filed on Mar. 7, 2008.

(51) Int. Cl. G06F 17/30

(52) U.S. Cl. 707/5; 707/3; 707/E17.008; 705/1; 707/E17.014

(57) ABSTRACT

A computer-implemented system and method for automatically sorting a plurality of business listings (i.e., business members) returned from a search query based on an overall-relevance value previously assigned to each business member. Business members with corresponding higher-overall-relevance values are ranked as more relevant than business members with lower-overall-relevance values. The overall-relevance value is generated based on weighted scores corresponding to different parameters associated with the business member. These weighted scores are cumulatively combined to generate the overall-relevance value assigned to the business member and is stored in a database.

### CROSS REFERENCE TO RELATED APPLICATIONS

The present patent application claims benefit of U.S. Provisional Application Ser. No. 61/068,616 filed on 7 Mar. 2008, incorporated herein by reference.

### BACKGROUND

Search engines usually display search results in a listing format, with the more relevant results listed higher on the list. To peruse a search-result listing, a user clicks on a particular search result (i.e., a link) that appears to be promising. The page corresponding to the selected search result is then loaded and displayed. Search engines usually return search results to browsers in a listing format.

Searching for, and finding relevant information about a business—such as a company or service provider—on the Internet is often challenging; especially when a user does not know the name of the business, or whether a business exists within a particular locale. There are several reasons why internet searches do not always list the most relevant businesses.

Firstly, the internet contains an astronomic amount of information, and is ever increasing in size, making it increasingly difficult to find and return results to the user that are meaningful/relevant to a search query. As a result, searches often return thousands of irrelevant listings per search.

Secondly, commercial-search engines, such as Google® and Yahoo!®, are geared to the general user, and employ ranking models that are designed for breadth and popularity. Ranking demonstrates the relevance of an entity to a given user query. These search engines, therefore, elevate listings of businesses that appear to receive higher-hit rates and have more updated content. Additionally, these commercial-search engines often use ranking models that permit businesses to manipulate their ranking listing by purchasing key words and/or advertisements associated with certain search terms.

While commercial-search engines tend to return search results that appear more popular, these results often lack relevance for a significant number of users. Additionally, less savvy or smaller internet businesses can go undetected by commercial-search engines that employ popularity-geared ranking models. In other words, commercial-search engines are more likely to return search results that are automatically biased towards businesses with larger internet footprints.

### SUMMARY

To address the above-discussed deficiencies of the prior art, this invention provides, a ranking module that enables a search engine to provide more relevant search results with respect to business members of an online-business directory and/or social-network site.

In one embodiment, the search engine automatically ranks a set of generated business members (i.e., search results) based on a search query. For example, a search query may request a type of business corresponding to a specific category of businesses, which are located in a particular geographical location. The search engine may then rank business members which pertain to the location/category-search query based on the overall-relevance value assigned to each business member. The search engine may display business members with corresponding higher overall-relevance values at the beginning of a search-results list.

In one embodiment, weighted parameters associated with business members are used to determine the overall-relevance value for ranking businesses members. For instance, business members with more textual content per a fixed set of web pages, and/or having more social-network connections to other business members are generally ranked higher (i.e., more relevant) than business members with less content and/or social-network connections. Other weighted parameters may also be measured and included as factors in determining relevance of relative business members.

In one embodiment, the search engine is a vertical-search engine, which means a search engine for searching databases limited to one or more particular sites.

In one embodiment, the search engine is used on a website that may be a business directory in which business members can display and sell, their respective products or services directly to users in real-time from the business directory (not from the business-member's independent (own) website).

In another embodiment, the search engine is used on a website that may be an online social-network site, in which business members, can display and sell, their respective products or services directly to users in real-time from the social-network site. As part of the social-network site members and intended registered users may include businesses rather than individuals. Further, a business-directory site and a social-network site may also be integrated, to offer a business directory and social networking forums in a single site, i.e., a combined online-business directory and social-network site.

In one embodiment, a computer-implemented method automatically sorts a plurality of business listings (i.e., business members) returned from a search query based on an overall-relevance value previously assigned to each business member. Business members with corresponding higher-overall-relevance values are ranked more relevant than business members with lower-overall-relevance values.

In one embodiment, the overall-relevance value is generated based on weighted scores corresponding to different parameters associated with the business member. These weighted scores are cumulatively combined to generate the overall-relevance value assigned to the business member stored in a database.

For example, the overall-relevance value (ORV) for a business member is generated according the following equation: ORV=the summation of the product of each W*Sₚ; wherein ORV is the overall-relevance value, W is a weighting factor, Sₚ is a measured score associated with a parameter.

In one embodiment, each score associated with a business member is generated by measuring at least one of the following parameters, and assigning a numeric value corresponding to the measurement:
(A) the amount of textual content detected on a fixed set of initial web pages associated with the business member;
(B) the number of social-network connections a business member may have with other business members;
(C) the number of reviews a business member has received;
(D) the quantity of products in a marketplace offered by a business member;
(E) the number of blog posts associated with the business member; and/or
(F) the number of chat rooms associated with the business member.
   Each score is multiplied by a weight factor, with a highest-weight factor assigned to the parameter at the top of the list (e.g., parameter A above), and a lowest-weight factor assigned to parameter at the bottom of the list (e.g., parameter F above). Weight factors may decrease in value each parameter level. In other words, those parameters listed at the top of the list are viewed as more important in determining relevance of a particular business member than those parameters toward the bottom of the list. It is appreciated by those skilled in the art having benefit of this disclosure that the weighted importance assigned to each parameter above may vary.

Additionally, parameters associated with a business member may include other suitable parameters not listed above. For example, other measured parameters may include the number of employees of a business, whether a business is minority owned, whether a business is a franchise or local business, and various other suitable parameters. Additionally, one or more of the above-listed parameters may not be included in determining the ORV, such as parameter A, or any other suitable parameter above.

The foregoing summary provides an exemplary overview of some aspects of the invention. It is not intended to be extensive, or absolutely require any key/critical elements of the invention.

### BRIEF DESCRIPTION OF THE DRAWINGS

The detailed description is explained with reference to the accompanying figures. In the figures, the left-most digit(s) of a reference number identifies the figure in which the reference number first appears.

The detailed description is explained with reference to the accompanying figures. In the figures, the left-most digit(s) of a reference number identifies the figure in which the reference number first appears.

FIG. 1 shows a network environment (an exemplary-network architecture) within which the present invention can be either fully or partially implemented.

FIG. 2 illustrates an exemplary computing device.

FIG. 3 illustrates an exemplary method for assigning overall-ranking values to business members in a site.

FIG. 4 illustrates an exemplary method for generating documents (i.e., business members) based on a search query.

### DETAILED DESCRIPTION

### Exemplary Terminology

Reference herein to “one embodiment”, “an embodiment”, or similar formulations herein, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

As used herein, a “business directory” is an online-website publication including listings for a plurality of businesses, commercial entities, and/or public/private organizations. Each listing may include, for example, the name, address, and contact information of an entity on the site. The listings may be alphabetically or otherwise organized. For example, entities may be classified according to a relevant category or categories of products or services offered by the respective entity. It is noted that reference to the term “business” may include any public/private organizations, but does not generally refer to a non-business entity such as a person. In one embodiment, business directory not only facilitates the ability for business directories to list information about the business itself as traditional directories. But it also permits the businesses, themselves, to customize their own listings on the business directory to include products/services available for direct sale to users of the business-directory website, itself. So, a user does not have to leave the business-directory website to purchase products/services of a business listed in the directory.

In one embodiment, a “business member” means a business entity that pays or registers to list their business on an online-business directory and/or social-network site. As appreciated by those skilled in the art, after having the benefit of this disclosure, however, a “business member” may include businesses that are not necessarily affiliated with a particular online-business directory and/or social-network site, and therefore, do not pay or register to be a part of site.

As used herein, a “social-network site” (SNS) is an online, web-based site that enables a registered user (e.g., a member): (a) to create a public profile within a bounded site; (b) to identify others with whom the registered member shares a connection, and (c) to view and traverse the registered member's list of connections and those lists of connections made by others within the system.

In one embodiment, a business member of an SNS may customize their own listings on the SNS to include products/services available for direct sale to members of the SNS. A member, therefore, does not have to leave the SNS to purchase products/services of a business in the SNS.

As used herein, an “online-business directory and/or social-network site” means an independent website that includes a collection of web pages, images, videos, content or other digital assets all directed to a business directory, a social, or some hybrid combination of two; and all hosted on one or several Web server(s), usually accessible to users or members of the site via the internet, or some other network.

### Exemplary System Environment

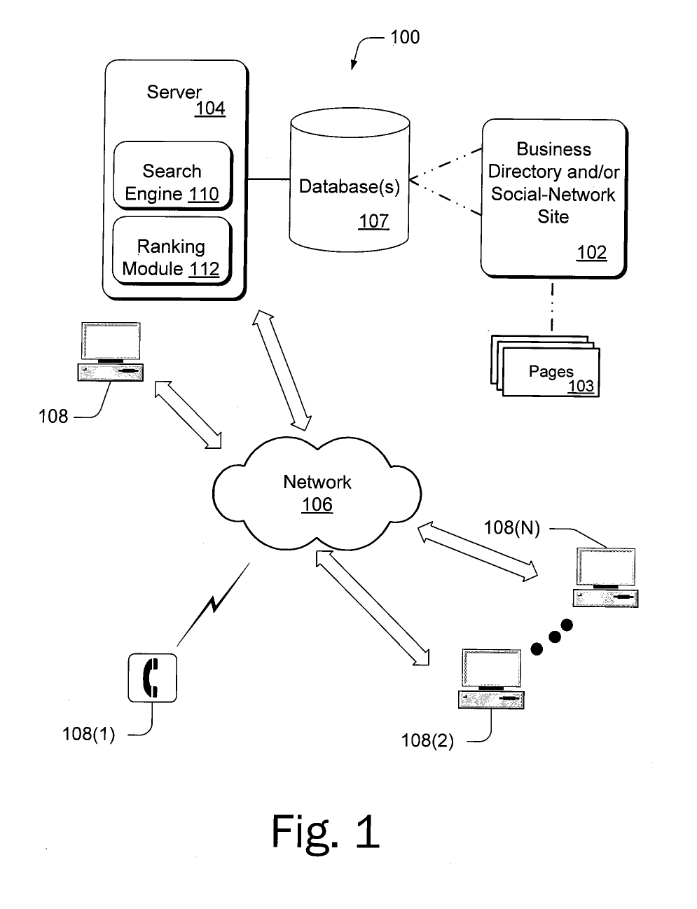

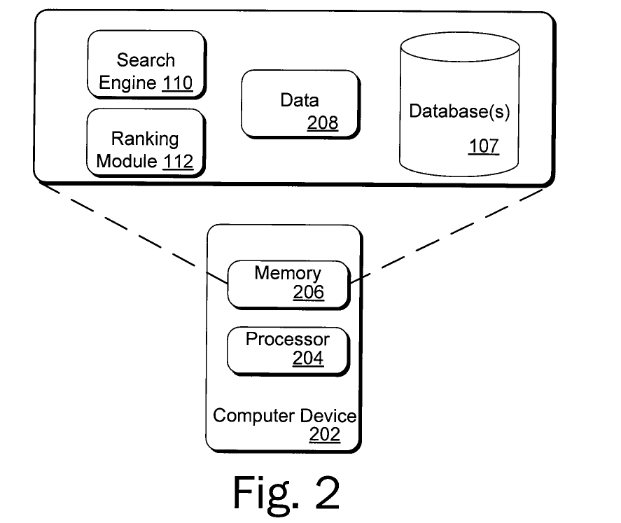

For example, FIG. 1 shows a network-architecture system 100 within which the present invention can be either fully or partially implemented. In one possible embodiment, system 100 includes an online-business directory and/or social-network site 102 hosted by at least one server 104. One or more users or members of site 102 may connect to it via a network 106 (such as the Internet) and the user/member's client-side computers 108(1), 108(2), 108(N). As appreciated by those skilled in the art, server 104 and client-side computers 108 may be implemented as any suitable computer processing system, such as the representative system (computing device) shown in FIG. 2 (described below).

Also, as appreciated by those skilled in the art, server 104 and client-side computers 108 may utilize any suitable combination of communication protocols and computer-program applications (code) to communicate with each other, such as, but not necessarily limited to Hypertext Transfer Protocol (HTTP), Transmission Control Protocol/Internet Protocol (TCP/IP), Wireless Application Protocol (WAP), and a myriad of other protocols/applications.

In one embodiment, site 102 includes a collection of related data, pages (e.g. 103), files, etc. relating to different members that are typically stored in one more databases 107. Server 104 transmits the collection of data from site 102 to a user/member via their client-side computer 108 (and via network 106), based upon requests made by the client-side computer 108. For example, a user may request a web page, that is displayed on a client-side computer 108. Typically, site 102 includes a “home page,” which usually serves as the first and main page to any website, as is well known to those skilled in the art.

Server 104 includes search engine 110. A search engine is software (i.e., code in the form of computer executable instructions and data, and an allocation of computational resources) configured for searching a set of information resources, such as stored in databases 107. Server 104 executing a search engine 110 generates search results for search queries submitted by users via client-side computers 108. The search results are commonly referred to in the industry as “documents,” which is a unit of data that is indexed by the search engine (or database 107). While search engine 110 is shown as single entity, it is appreciated that there may be multiple search engines and different sets of indexes.

In one embodiment, search engine 110 is a vertical search engine that indexes documents pertaining to online-business directory and/or social-network site 102. As appreciated by those skilled in the art, however, search engine 110 may be used in conjunction with other domains including more general web-search engines such as Google® or Yahoo!® search engines.

Generally, search engine 110 generates a search result, which is includes a listing of documents (e.g., in one embodiment business members), and each listing may contain summary information about each document. The list of documents is ordered. Search engine 110 assigns a rank to each document in the list. When sorted by relevance, a document with relatively higher rank may be placed closer to the top of the list than a document with a relatively lower rank. Relevance is a measure of how closely a document (e.g., business members) matches a search query's terms.

Ranking module 112 is software—i.e., code in the form of computer executable instructions and data, and an allocation of computational resources. Ranking module 112 is configured to assist search engine 110 return relevant documents to a user by ranking the set of documents identified by the search engine 110.

Ranking module 112 automatically creates an overall-ranking value (ORV) that is assigned to suitable documents stored in database 107. Specifically, in one embodiment, ranking module 112 automatically assigns an ORV to each business member of site 102. Ranking module 112 continually updates the ORV for each business member, as parameters associated with the member change. The ORV is indexed with (i.e., assigned to) each business member or other documents as part of database 107. Exemplary methodologies for generating the ORV will be described in more detail below. As appreciated by those skilled in the art, after having the benefit of this disclosure, ORVs may be assigned to other suitable documents.

Search engine 110 is launched to locate/fetch a set of documents (e.g., units of data corresponding to business members) in response to a search query received by server 102. For instance, the search query may request a specific category of businesses in a specific geographical area. In response to the query, search engine 110 may locate/fetch a set of business members, previously indexed in database 107, that satisfy (i.e., generally match the search request) the query. The general process of indexing and searching for indexed documents containing predetermined terms is known in the art, and will not be described further herein.

Search engine 110 is able to sort the set of business members, based on the ORV previously assigned to each business member by ranking module 112. For example, those business members of the set with higher ORVs are placed towards a top of a search-results list for display to a user. That is, when sorted for relevance, search engine 110 is able to place a document with relatively higher-assigned ORV closer to a top of a search-results list than a document with a relatively lower-assigned ORV. It is noted that the document listed as part of the search results, such as a business member, is usually in the form of any suitable hyperlink.

In one embodiment, ranking module 112 is intertwined with code of search engine 110, although it may be a separate component of code. As appreciated by those skilled in the art, searching engine 110 and ranking module 112 are stored in memory, described with reference to FIG. 2.

FIG. 2 illustrates an exemplary computing device 202, which may be representative of server 104 or client-side computer 108. Generally, these devices may be any of a variety of computer devices, including desktop PCs, servers, mainframes, workstations, notebook or laptop computers, hand held or portable PCs, personal digital assistants (PDAs), cellular phones, Internet appliances, gaming consoles, portable communication devices, televisions/set-top boxes, wireless devices, multiprocessor systems, microprocessor systems, programmable consumer electronics, multimedia systems, a combination of any of the above example devices, and other smart devices.

Computing device 202 includes at least one processor 204 and memory 206. Memory 206 may include any computer-readable medium known in the art, including volatile memory (e.g., RAM) and/or non-volatile memory (e.g., ROM, PCMCIA cards, etc.). In some implementations, memory 206 is used as part of a computer's cache, permitting application data to be accessed quickly without having to permanently store data in a non-volatile memory device.

Resident in memory 206 are one or more operating systems (not shown), and code (such as search engine 110 and ranking module 112) that executes on processor 204. For purposes of illustration, programs and other executable program modules are illustrated herein as discrete blocks, although it is recognized that such programs and components reside at various times in different storage components of device 202, and are executed by the one or more processors. Memory 206 may also include databases 107 and other data 208. For instance search engine 110 may generate various types of data 208 that may be required by server 102 during a search.

Other elements such as power supplies, keyboards, touch pads, I/O interfaces, displays, LEDs, audio generators, vibrating devices, and so forth are not shown as being a part of device 202, but could easily be a part of any such device. Additionally, although not shown, a system bus or point-to-point connections typically connects the various components within device 202. It is noted that computer-executable instructions (code) forming memory 206 may be located in both local and remote computer storage media, including memory storage devices (computer-readable media).

### Exemplary Ranking Methods

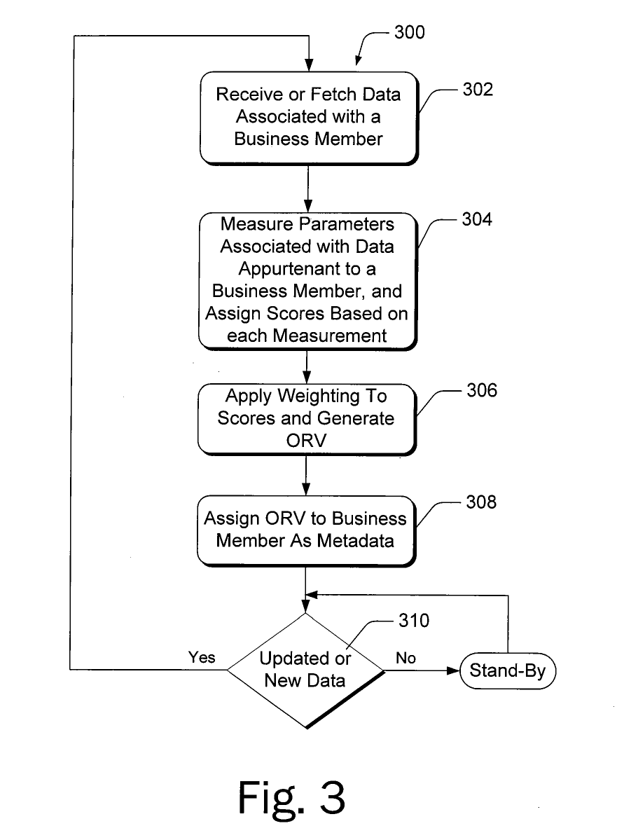

FIG. 3 illustrates an exemplary method 300 for assigning overall-ranking values to business members on site 102. Method 300 includes blocks 302, 304, 306, 308, and 310. Each of the blocks represents one or more operational acts. The order in which the method is described is not to be construed as a limitation, and any number of the described method blocks can be combined in any order to implement the method. Furthermore, the method can be implemented in any suitable hardware, software, firmware, or combination thereof. Additionally, although each block in FIG. 3 is shown as a single block, it is understood that when actually implemented in the form of computer-executable instructions, logic, firmware, and/or hardware, that the functionality described with reference to a block may not exist as separate identifiable block.

Referring to FIG. 3, in block 302, ranking module 112 fetches or receives updated data associated with an existing member or a new business of site 102 (FIG. 1). In one implementation, the data includes web pages containing content and metadata appurtenant to the business member. Content may include any information capable of viewing on web pages, such pictures, video, icons, and text. Metadata may include information about the business member that may or may not be visible on the web pages.

In block 304, ranking module 112 measures one or more parameters associated with data appurtenant to the business member, and assigns a score (i.e. a numerical value) based on each recorded measurement. In one embodiment, the parameters measured may include the following:
(A) the amount of textual content detected on a fixed set of initial web pages associated with the business member;
(B) the number of social connections a business member may have with other business members;
(C) the number of reviews a business member has received;
(D) the quantity of products in a marketplace offered by a business member;
(E) the number of blog posts associated with the business member; and/or
(F) the number of chat rooms associated with the business member.

With respect to parameter A, ranking module 112 may measure the amount of textual content detected on a fixed set of initial web pages associated with the business member. For example, ranking module 112 may measure how many words are used on the first three pages of a particular business. Those business members measured as having more content received receive a high score than those members with less textual content. As appreciated by those skilled in the art, the quantity and selection of pages can vary.

With respect to parameter B, ranking module 112 may measure the number of social-network connections a business member may have with other business members. As used herein, the term “social-network connection” is a type of connection used on SNSs. Such a connection enables a registered user of site 102 (e.g., a member): (a) to create a public profile within a bounded site; (b) to identify others with whom the registered member shares a connection, and (c) to view and traverse the registered member's list of connections and those lists of connections made by others within the system. The social-network connections may include business-to-business and business-to-consumer connections. The score generated may be equal to the number connections.

With respect to parameter C, ranking module 112 may measure the number of reviews a business member has received. The reviews may be written reviews or simple scaling ratings made by other members or users of site 102. The score generated may be equal to the number of reviews made during some suitable predefined-time period.

With respect to parameter D, ranking module 112 may measure a quantity of products offered by a business member on the site, and assign a score equal to the number of products.

With respect to parameter E, ranking module 112 may measure the number of blog posts associated with the business member on site 102, and assign a score equal to the number of blog posts.

With respect to parameter F, ranking module 112 may measure the number chat rooms associated with a business member on site 102 (or products/services associated with the business member), and assign a score equal to the number of chat rooms. As used herein, chat room may include any central-conferencing or communication section of site 102, in which users may communicate with each other.

As appreciated by those skilled in the art having the benefit of this disclosure, parameters associated with a business member (or other type of document) may include other suitable parameters not listed above. For example, other measured parameters may include the number of employees of a business, whether a business is minority owned, whether a business is a franchise or local business, and various other suitable parameters. Additionally, any parameters listed may not be included such as, but not necessarily limited to, parameter A.

In block 306, a predetermined-weighting factor corresponding to each parameter is applied to each parameter score determined in block 304. In one embodiment, the overall-relevance value is generated based on weighted scores corresponding to different parameters associated with the business member. These weighted scores are cumulatively combined to generate the overall-relevance value assigned to the business member stored in a database. For example, the ORV for a business member is generated according the following equation: ORV=the summation of the product of each W*Sₚ; wherein ORV is the overall-relevance value, W is a weighting factor, Sₚ is a measured score associated with a parameter.

In one embodiment, a higher weighting factor is assigned to those parameters at the top of the list (parameter A-F above), with the highest weighting factor assigned to the parameter at the top of the list (e.g., parameter A above), and a lowest-weight factor assigned to the parameter at the bottom of the list (e.g., parameter F above). Weight factors decrease in value each letter down. In other words, those parameters listed at the top of the list are viewed as more important in determining relevance of a particular business member than those parameters toward the bottom of the list. It is appreciated by those skilled in the art having benefit of this disclosure that the weighted importance assigned to each parameter above may vary.

In blocks 308 and 310, the ranking module 112 continually and automatically correlates ORVs with business members (or other documents). Typically, the ORV is stored in a suitable metadata format that may include an identification tag to correlate the ORV with the business member. Thus, in block 308 the ORV is generated and is stored future use by search engine 110. And in block 310, the ORV is updated or created per business member, in an iterative fashion, whenever data is updated or a new business member joins site 102.

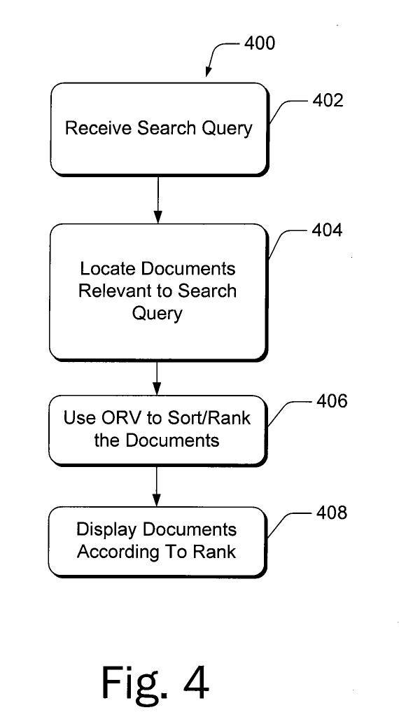

FIG. 4 illustrates an exemplary method 400 for generating documents (i.e., business members) based on a search query. In one implementation, method 400 is applied by search engine 110 to rank documents located from a search. Method 400 ranks documents based on the ORV assigned to each document (i.e., business member) generated by the method 300 described in FIG. 3.

Method 400 includes blocks 402, 404, 406, and 408. Each of the blocks represents one or more operational acts. The order in which the method is described is not to be construed as a limitation, and any number of the described method blocks can be combined in any order to implement the method. Furthermore, the method can be implemented in any suitable hardware, software, firmware, or combination thereof. Additionally, although each block in FIG. 4 is shown as a single block, it is understood that when actually implemented in the form of computer-executable instructions, logic, firmware, and/or hardware, that the functionality described with reference to a block may not exist as separate identifiable block.

In block 402, a search query is received by search engine 110. For example, a search query may be received by server 104 from client-side computer 108 via network 106.

In block 404, search engine 110 locates/fetches those documents relevant to the search query. Search engine 110 is launched to locate a set of documents (i.e., set of business members) in response to a search query received by server 102. For instance, the search query may request a specific category of businesses in a specific geographical area. In response to the query, search engine 110 may locate a set of business members, previously indexed in database 107, that satisfy (i.e., generally match the search request) the query.

In block 406, search engine 110 sorts/ranks the set of business members, based on the ORV previously assigned to each business member by ranking module 112. For example, those business members of the set with higher ORVs are ranked (i.e. placed) towards a top of a search-results list for display to a user. That is, when sorted for relevance, search engine 110 is able to place a document with relatively higher-assigned ORV closer to a top of a search-results list than a document with a relatively lower-assigned ORV.

In block 408, the sorted documents (i.e., links thereto)—also referred to as a search-results list—are arranged as a set of data by server 104 for transmission and display as one or more web pages on a browser operating on a client-side computer 108. For example, the search-results list may be stored in a suitable format for transmission and display on a client-side computer. The search-results list may also be stored in one or more databases. Those documents with higher relevance may also be highlighted (e.g. bolded) to further distinguish them from other listings.

Although various embodiments have been described above with reference to flowcharts and/or block diagrams, it is appreciated by those skilled in the art, after having the benefit of this disclosure that any blocks or functionality described therein may be implemented in code executed by a processor.

The embodiments described herein are to be considered in all respects only as exemplary and not restrictive. The scope of the invention is, therefore, indicated by the subjoined Claims rather by the foregoing description. All changes which come within the meaning and range of equivalency of the Claims are to be embraced within their scope.

What is claimed is:

1. A computer-implemented method for ranking a business member, comprising:
(a) receiving data associated with a business member;
(b) measuring parameters associated with data appurtenant to the business member, and generating scores corresponding to each measured parameter;
(c) applying predetermined-weighting factors corresponding to each of the scores to arrive at weighted scores corresponding to each parameter;
(d) generating an overall-ranking value by cumulatively combining the weighted scores to generate the overall-relevance value for the business member; and
(e) assigning the overall-ranking value, in the form of metadata, to a document corresponding to the business member.

2. The method of claim 1, further comprising repeating the operational acts performed in paragraphs (a)-(e) for a plurality of business members.

3. The method of claim 2, further comprising receiving a search query, and fetching a set of documents corresponding to business members matching the search query.

4. The method of claim 2, further comprising receiving a search query, fetching a set of documents corresponding to business members matching the search query, and ranking the set of documents, based on at least one of the overall-ranking values previously assigned to each business member.

5. The method of claim 2, further comprising receiving a search query, fetching a set of documents corresponding to business members matching the search query, and ranking the set of documents, based on at least one of the overall-ranking values previously assigned to each business member, and arranging the sorted set of documents for transmission and display as a search-result list on a client-side computer.

6. A computing device comprising: a processor; a memory configured to the processor; and a search engine and ranking module in the memory configured to: receive data associated with business members; measure parameters associated with data appurtenant to each of the business members, and generate scores corresponding to each of the measured parameters; apply predetermined-weighting factors corresponding to each of the scores to arrive at weighted scores corresponding to each measured parameter; generate an overall-ranking value by cumulatively combining the weighted scores to generate the overall-relevance value for the business members; and assign the overall-ranking value, in the form of metadata, to a document corresponding to a respective one of the business members.

7. The computing device of claim 6, wherein the search engine and ranking module in the memory are further configured to: receive a search query, and fetch a set of documents corresponding to business members matching the search query.

8. The computing device of claim 6, wherein the search engine and ranking module in the memory are further configured to: receive a search query, fetch a set of documents corresponding to business members matching the search query, and rank the set of documents, based on at least one of the overall-ranking values previously assigned to each business member.

9. The computing device of claim 6, wherein the search engine and ranking module in the memory are further configured to: receive a search query, fetch a set of documents corresponding to business members matching the search query, and rank the set of documents, based on at least one of the overall-ranking values previously assigned to each business member, and arrange the sorted set of documents for transmission and display as a search-result list on a client-side computer.

10. A computer-implemented method for ranking documents comprising: receiving a user query; retrieving documents relevant to the user query; ranking the documents according to an overall-ranking value corresponding to each of the documents, and arranging the ranked documents for transmission and display, wherein each of the documents is a unit of data corresponding to a business member associated with web site.
